(19) United States
(12) Patent Application Publication
(10) Pub. No.: US 2003/0110266 A1
(43) Pub. Date: Jun. 12, 2003

(54) Apparatus and method of using session state data across sessions

(75) Inventors: Gregory L. Rollins, Middletown, MD (US); Roy E. Willingham, Montgomery Village, MD (US); Sawat Hannsirisawat, Fairfax, VA (US); Joseph A. Swingle, Alexandria, VA (US); Daniel E. Cox, Alexandria, VA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Cysive, Inc.

(21) Appl. No.: 10/013,745

(22) Filed: Dec. 10, 2001

(51) Int. Cl. G06F 15/16

(52) U.S. Cl. 709/227; 709/203

(57) ABSTRACT

A process is provided to allow session state data to be used across sessions. In the process, a first session is established. The first session includes session state data. Then, a second session is established. It is then determined if the second session desires to access session state data established by the first session. If so, at least some of the session state data from the first session is used during the second session to establish the initial session state during the second session.

### BACKGROUND OF THE INVENTION

HTTP is a stateless protocol because there is no information about what occurred previously. Absent any session tracking techniques, The World Wide Web is also stateless because it runs on top of HTTP. Accordingly, each request for a new web page is processed without any knowledge of previous pages requested. Thus, a new connection is established for each client request to a server and no state information is maintained between requests. That is, a web server treats each HTTP request as an independent request. The web server has no knowledge of previous requests, even if they occurred seconds prior to a current request. Consider an example of a website that contains a document broken up into 10 web pages of text. If user 1's browser requests page 1, then page 2, and so on, even when user 1 requests page 10, the web server still does not know that user 1, as opposed to some other user, has requested page 10. Put simply, when a browser asks for a web page, the web server delivers the web page, without regard for who requested it.

A “session” is a continuous (non-permanent) connection from a browser to a server over a fixed period of time. No session is established in the example above because each request for a new web page establishes a new connection. Business-oriented web applications, such as e-commerce applications, generally need to be able to track a user's previous requests along with certain information associated with those requests. Such applications thus need the ability for the user to establish a session between the browser and the server and maintain state information associated with that session. There are numerous well-known techniques of establishing and maintaining sessions that allow for storing and tracking of state information. These techniques include the use of session cookies, hidden form fields, and URL rewriting (i.e., embedding data in URLs).

Session management is the ability to maintain user information over the course of a visit (i.e., session) as the user travels from web page to web page in an application. In one conventional technique, a unique identification number is assigned to each client who requests to communicate with a website so that the website can identify the client in subsequent communications within the same session. The unique identification number is typically referred to as a session identifier (hereafter, “session ID”). In another conventional technique, the session ID is stored in a session ID cookie. That is, the session ID cookie contains only the session ID. The website creates the “session ID cookie” and sends it to the client. The session ID cookie is then stored in a pre-specified file in the client's browser. Session ID cookies are non-persistent and are automatically deleted from the client's computer after the browser is closed. If a client requests a subsequent communication with the website that created the session ID cookie, the browser sends the session ID cookie (which contains the session ID) with the HTTP request as HTTP request header fields. The name of the session ID cookie is application server specific. The website then stores data specific to the session, associated with the session ID. The session ID is typically associated with state data, but may also contain other data that is not state-specific. The combination of the “state data” and “other data” that is associated with the session ID is also referred to herein as “session data.”

FIGS. 1-3, taken together, illustrate a conventional session management process for applications that is used to keep track of the state of each user. In this example, two different registered users 1 and 2 establish sessions, via a public network such as the Internet, with a website server at address www.buystuff.com. Consider, for example, user 1, session 1. User 1 sends a first request to website www.buystuff.com (step 10) device 1. Since this is a first request during a browser session to www.buystuff.com, no session has been created and no session ID cookie exists in the HTTP request header field. That is, a first request by a browser to a URL does not contain a session ID. On the server side, this fact is detected (step 12, “NO” output), a new session is created, and a session ID cookie (containing a newly created unique session ID) is created. The session ID cookie is then communicated back to the browser with the first response (step 14), and is stored by the client for use in the header of subsequent requests sent to the server. In this manner, the server can now identify subsequent requests from the same source.

On the server side, session specific data is associated with the session ID. In the example of FIG. 2, the session data include session ID (the association), login ID, session state data (e.g., where was the last place that the user went (current page), and data associated with where the user was last), and other attributes that are not related to session state data. The session ID is logged into a list of “unexpired” session ID's. Sessions are typically programmed to expire after a certain period of inactivity, such as 30 minutes. For example, if more than 30 minutes passes between client requests, the session expires and is no longer valid. Upon expiration, the session ID is removed from the list of valid sessions and the associated data is deleted. The website application program may also decide to delete a valid session at any time for application specific reasons, such as detection that the user has logged out. An unexpired session ID is merely one that has not yet expired due to inactivity or the occurrence of a specific trigger event.

Referring again to FIG. 1, if the client request includes a session ID cookie (step 12, “YES” output), then a previous session has already been established and the server must check its table to determine if an unexpired and valid session ID exists at the server (step 16). If an unexpired and valid session ID does not exist at the server, then a new session ID is allocated, and a session ID cookie (containing the newly allocated unique session ID) is created. The session ID cookie is then communicated back to the browser with the first response (step 14), and is stored in the client device for use in the header of subsequent requests sent to the server. If an unexpired and valid session ID exists at the server, then the client request is executed and the data in the session is updated (step 18) as necessary.

In the example of FIG. 2, users 1 and 2 initiated a first session using respective desktop computers, labeled as devices 1A and 1B. The session data for user 1, session 1 indicates that the last request made by user 1 was for webpage 2, and that session state data for data1 and data2 equals variable1 and variable2, respectively. The session data for user 2, session 1 indicates that the last request made by user 2 was for webpage 64, and that session state data for data1 and data2 equals variable1 and variable2, respectively. The session ID's for both users are currently unexpired and valid, and thus both session ID's are present in the table.

In the example of FIG. 3, users 1 and 2 have closed their browsers and have initiated new communications with the website www.buystuff.com. In this example, user 1 initiates a second session from a new device 2, here, a PDA, whereas user 2 initiates a second session from the same device 1B as the first time, here, a desktop computer. Since the initial requests by both users do not include a session ID cookie, then new session ID's must be created (steps 12, 14 of FIG. 1). User 1 is assigned session ID 456789, user 2 is assigned session ID 333337, and both of these values are entered into the table of unexpired session ID's. Currently, both users are at the homepage (i.e., current page=homepage). Since the second sessions are new, the session state data is also new, even though both users have logged in with their same login ID's (e.g., johndoe and marysmith) as in the first session. In the example of FIG. 3, the session ID of user 2, session 1 has not yet expired and thus the corresponding session ID is still present in the valid list. However, since user 2 closed the browser and initiated a new browser session, a new session is allocated for user 2 with a new session ID, and the session data created by user 2 during session 1 cannot be accessed during session 2. The session for user 1, session 1 has expired and thus the corresponding session ID is not present in the list. However, even if the session ID for user 1, session 1 did not expire and thus was present in the valid list, the corresponding session ID would also not be accessible to user 1 during the new PDA-based session 2.

The result of this process is that neither of the users retains their session state data across sessions. If user 1 wishes to view webpage 2 and continue with a session (e.g., an e-commerce transaction) that needs to use variable1 and variable2 in the session data associated with session ID 123456, then user 1 must repeat all of the steps (e.g., webpage requests, picking items to go in to a shopping cart, filling in fields of order data forms) that are required to get back to this point in the process. Likewise, if user 2 wishes to view webpage 64 and continue with a session that needs to use variable1 and variable2 in the session data associated with session ID 789012, then user 1 must repeat all of the steps that are required to get back to this point in the process.

Thus, session management processes, such as the use of session ID's, associated session data, and session ID cookies, do not provide a quick and convenient method to allow a user to reconvene with the state of a previous session. Nor do other conventional techniques for maintaining session state, such as URL rewriting, provide such a capability since they also rely upon the browser remaining open. The present invention provides such a capability without the necessity for a browser that began a session to remain open.

### BRIEF SUMMARY OF THE INVENTION

A process is provided to allow session state data to be used across sessions. In the process, a first session is established. The first session includes session state data. Then, a second session is established. It is then determined if the second session desires to access session state data established by the first session. If so, at least some of the session state data from the first session is used during the second session to establish the initial session state during the second session.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIGS. 1-3, taken together, illustrate a conventional session management process for applications that is used to keep track of the state of each user;

FIGS. 4-10, taken together, provide an overview of a session management process in accordance with the present invention that allows for the use of session state data across sessions;

FIG. 11 shows a detailed schematic diagram of the basic components of a non-persistent solution of the present invention that allows for the use of session state data across sessions; and

FIG. 12 shows a detailed schematic diagram of the basic components of a persistent solution of the present invention that allows for the use of session state data across sessions.

### DETAILED DESCRIPTION OF THE INVENTION

### I. Overview of Present Invention

The present invention allows session state data to be used across sessions. Most generally, the present invention operates as follows:

(a) A first session is established. The first session includes session state data.

(b) A second session is established.

(c) It is determined if the second session desires to access session state data established by the first session. If so, then at least some of the session state data from the first session is used during the second session to establish the initial session state during the second session.

The present invention may be implemented in many different ways. Two such implementations are described herein. A first implementation is a non-persistent solution. A second implementation is a persistent solution. The type of solution chosen depends upon the web site developer's preference for performance or fault tolerance. These solutions require significantly different steps and apparatus, and thus are described separately.

As background to the solutions, large websites today have a traffic load that is generally too big to be managed by one server. It is common practice to have multiple servers working in concert to provide enough processing power to meet the traffic load. When an individual establishes a session with a website, the actual session information may be maintained on any of multiple servers and may even be automatically moved to another server while the session is active. However, whether one or plural servers are used to handle server requests for a particular session, there is no guarantee that the same user (e.g., johndoe or marysmith) is always handled by the same server.

Since the present invention requires that the session data from the first session be made available for the second session, a scheme must be provided for sharing the session data between servers in such multiple server websites. Both the persistent solution and the non-persistent solution address this requirement.

The multiple server details are provided in the Detailed Disclosure section below. This overview section describes the present invention in the context of a single server website. However, the scope of the present invention covers single and plural website server embodiments.

Persistent Solution

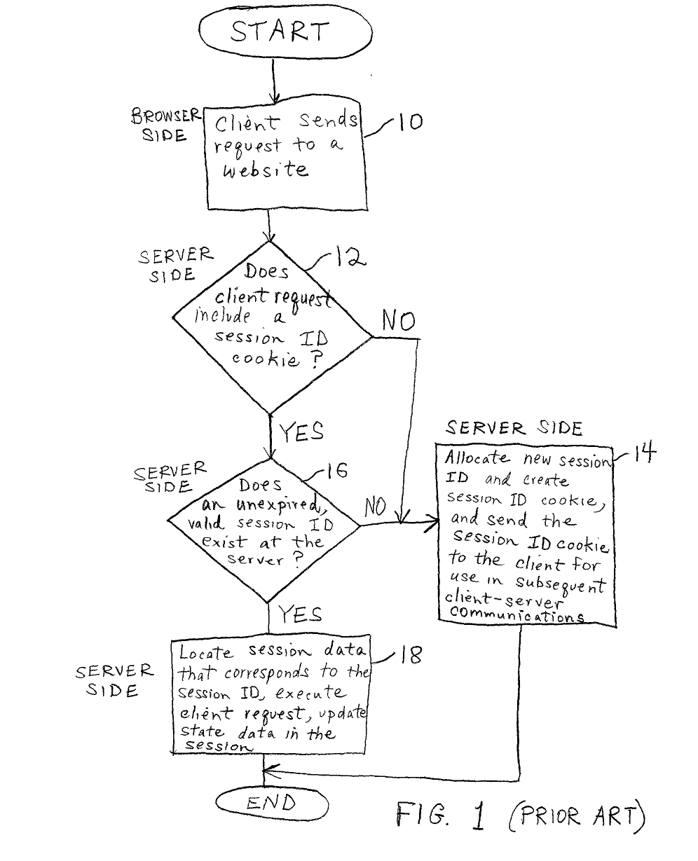

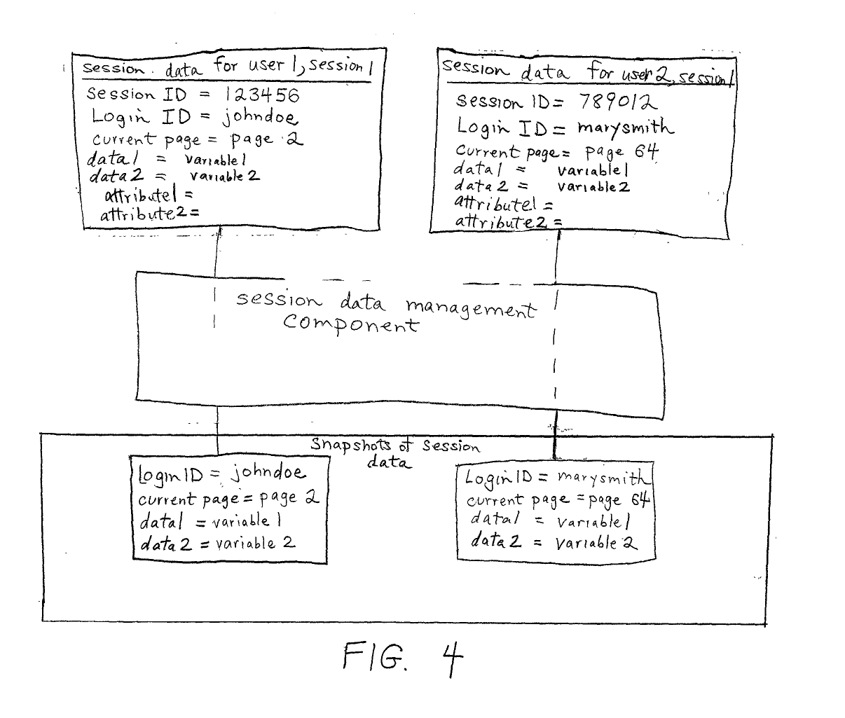

FIG. 4 through FIG. 8 provide an overview of the present invention in the context of the example in FIGS. 1-3. To implement the present invention, snapshots are taken of a subset of session data. The subset include some or all of the session data. The snapshots are updated, if necessary, whenever the data in the session is changed. The snapshots persist for an application-defined period of time. The snapshots may be stored within application data, in a separate database, or in a file. A session data management component, as described below, determines the exact contents of the snapshots. The snapshots include at least user identification data (e.g., login ID), and some state information, such as current page and corresponding data variables, that would allow a user to continue a session where the user left off without repeating any input steps or page requests. Session data that are not necessary to recreate the session state data of the session need not be stored in the snapshot. A snapshot thus contains a copy of at least some of the session state data and other session data.

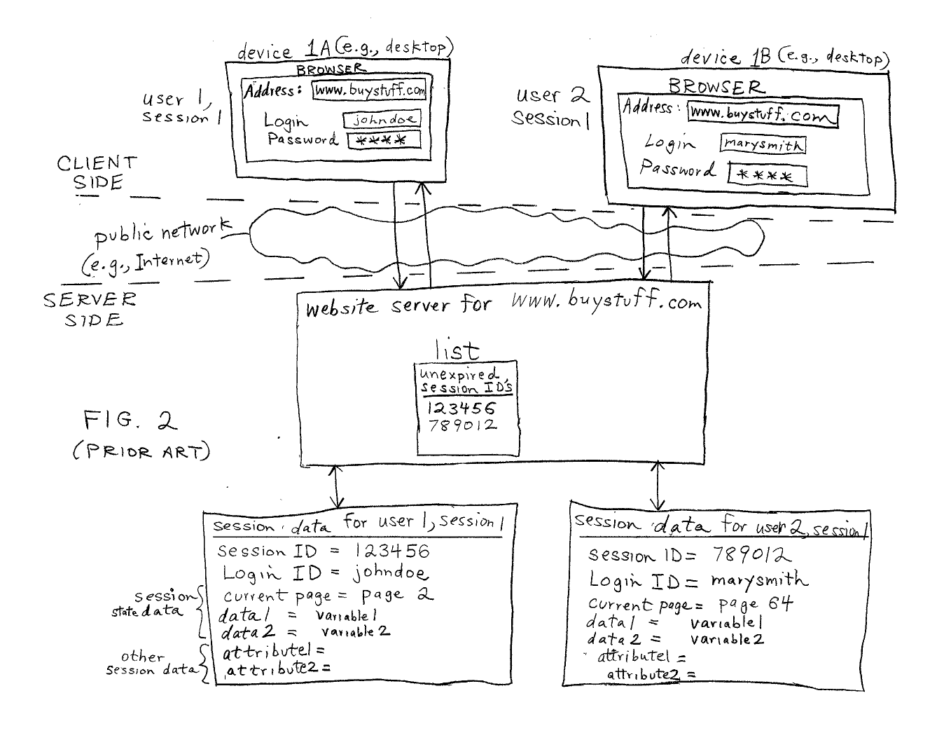

FIG. 4 shows an example of snapshots that would be taken for the current state of the session in FIG. 2. As discussed above, the snapshots need not store all of data in the session, since some of the data, and even session ID, may not be necessary to track the current session state.

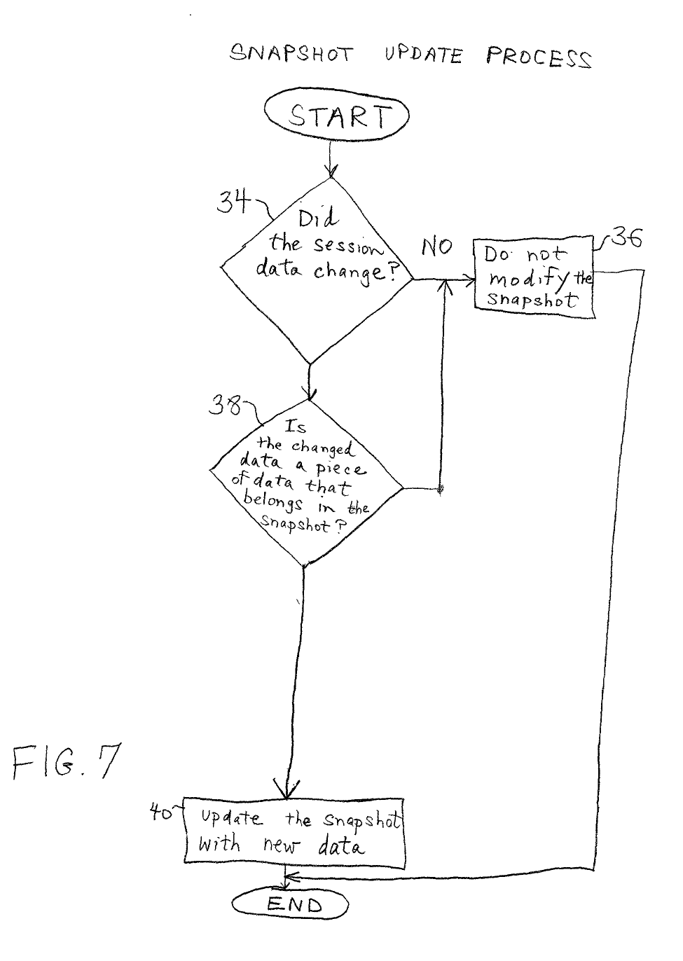

Session data management application logic, hereafter referred to as a “session data management component,” manages the flow of data between sessions and session snapshots. More specifically, the session data management component determines when, or if, a newly created session should be populated with data from a previously created snapshot, as well as which session data is maintained in the snapshots. The session data management component also controls the snapshot updating process described below in FIG. 7.

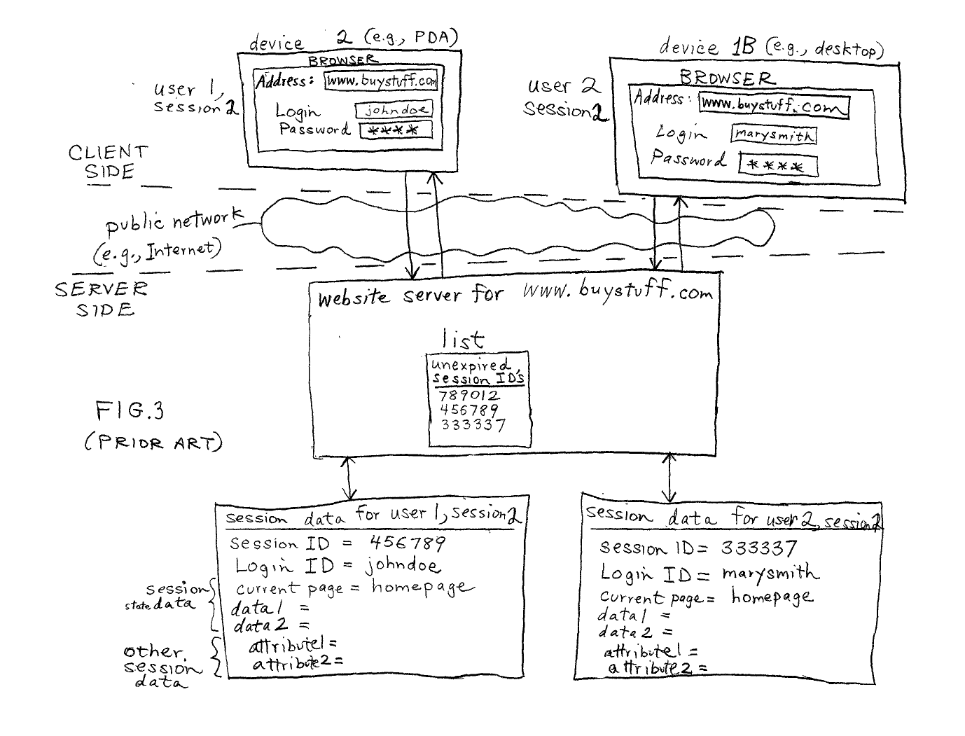

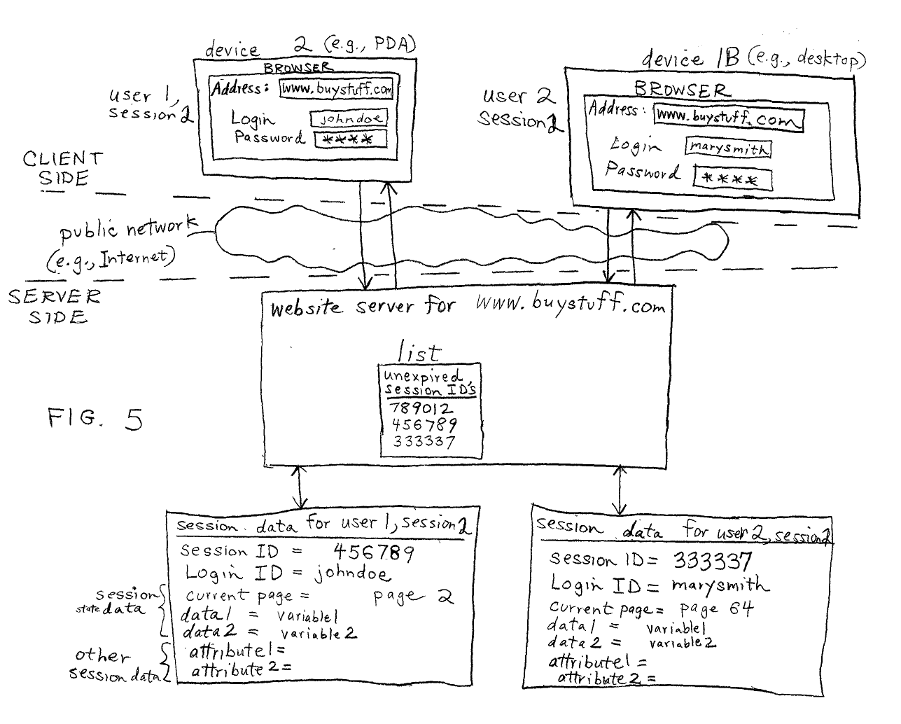

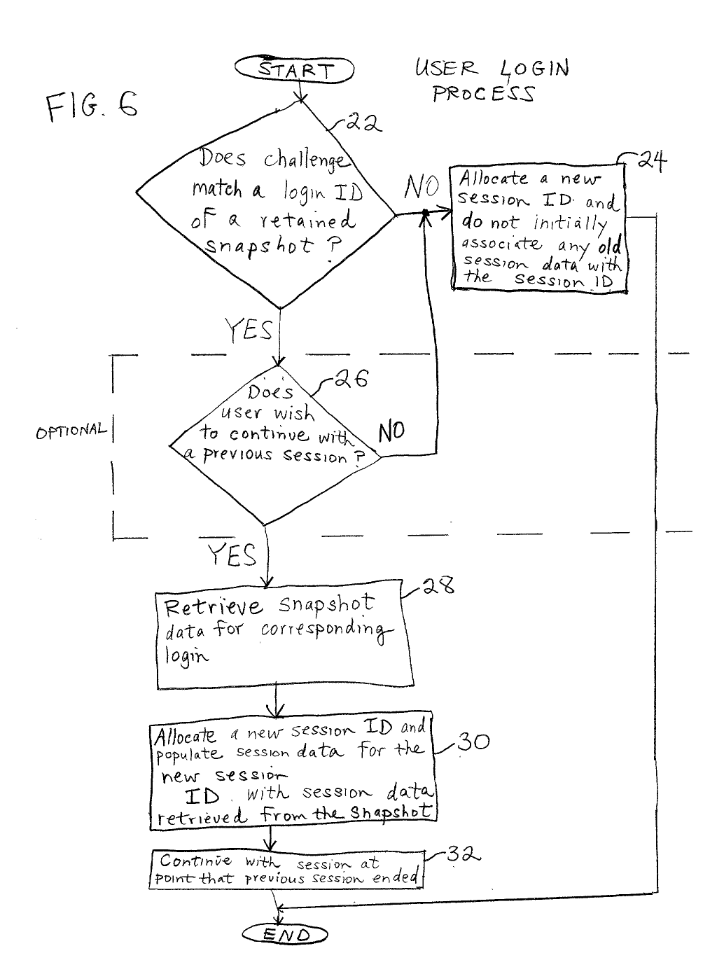

FIGS. 5 and 6 show how the snapshots are employed when users request to reconnect with the website server in the same manner as shown in FIG. 3. Referring to FIG. 5, challenge data (here, a login ID) is tested to determine if it matches a login ID of a retained snapshot (step 22). If not, then a new session ID is allocated as described above (step 24). The session data associated with the new session is not populated with any old session state data, and thus is similar to the new sessions created in FIG. 3. If the login ID matches a login ID of a retained snapshot (step 22, “YES” output), then the user is asked if they wish to continue with their previous session (step 26). If not, then a new session is created as described above (step 24). If the user wishes to continue with their previous session (step 26,, “YES” output), then the snapshot data associated with the login ID is retrieved (step 28). Step 26 is optional. Thus, when a login ID matches a login ID of a retained snapshot, step 28 may occur automatically without providing the user an option to start with new, unpopulated session state data. Since the user is making a first request to a website, the request does not contain any session ID cookie, as described above with respect to FIG. 1. Thus, session data is associated with a new session ID that is assigned to the session and sent back to the client for use in subsequent requests. However, unlike the example of FIG. 3, in the present invention, the snapshot data is used to populate associated session state data in the newly created session (step 30). Accordingly, data that is returned to the user in response to the initial request reflects the session state at the point in which the previous session ended (step 32). This difference is illustrated in FIG. 5 which shows that the session state data associated with the session ID is identical to the session state data of FIG. 2, instead of the new session state data shown in the session of FIG. 3, even though the session ID's of the sessions in FIG. 5 are the same as the session ID's of the sessions in FIG. 3. FIG. 5 thus illustrates that even though a user has started a new HTTP session, session state data can be retained and restored, even if a user changes device type (in the case of user 1). In FIGS. 3 and 5, the session ID's are identical so as to illustrate the user's experience in a conventional process (FIG. 3), compared to the user's experience when implementing the present invention (FIG. 5). In reality, session ID's would likely be different every time a new session is established.

FIG. 7 illustrates the snapshot update process which occurs after a request has been made. First, it is determined whether any changes occurred to the session data (step 34). If not, then no change or modification is made to the data in the snapshot. For example, some requests may not cause a change to the session data. If a change occurred to the session data, then it is determined whether the changed data is a piece of data that belongs in the snapshot (step 38). If so, then the snapshot is updated with new data. If not, then no change is made to the data in the snapshot. In the embodiment of the present invention disclosed in the Detailed Description section below, step 38 is performed using a data exclusion list which identifies the data that the snapshot should not contain. Any data that is not on the exclusion list is presumed to belong in the snapshot and is updated when necessary. In an alternative embodiment of the present invention, an inclusion list may be used instead wherein only data on the inclusion list is presumed to belong in the snapshot. The data that is stored in the snapshot may represent an update of data that currently exists in the snapshot, or it may represent new data that has come into existence for the first time and thus was not previously in the snapshot. The web application may also dictate that a certain piece of session data become part of the snapshot only after a certain point in the session, such as after the user has reached a predetermined stage in an e-commerce transaction, as detected by a specific session data change. Step 34 includes such a scenario.

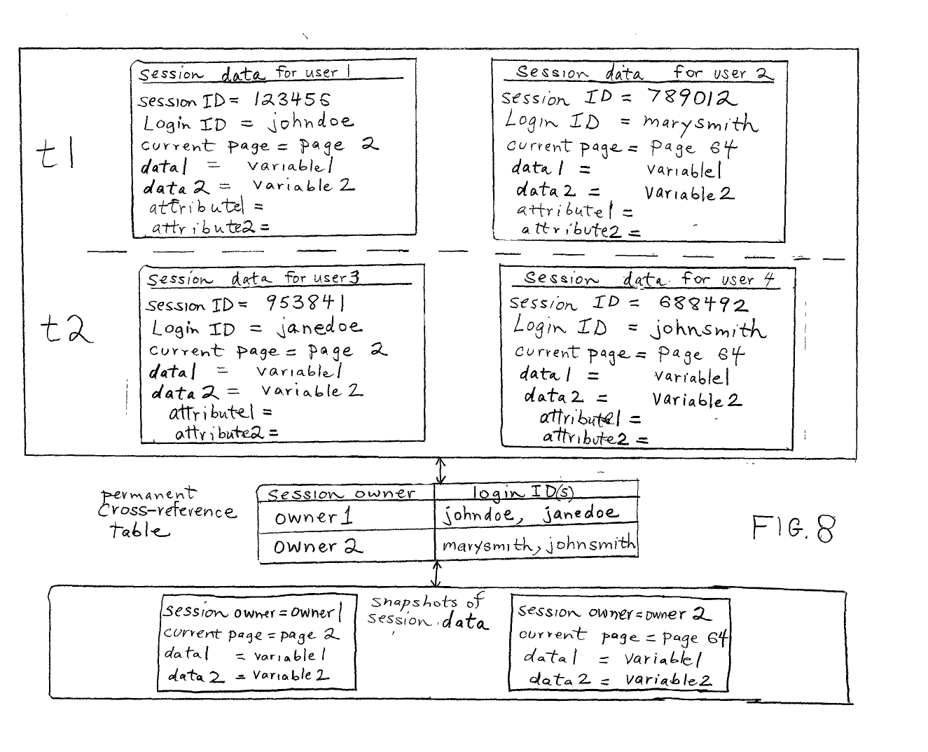

FIG. 8 illustrates an alternative embodiment of the present invention wherein plural session ID's may be defined by the same session owner. In this manner, plural users may share session state data so that a first user may initiate a session and stop using the session in mid-state (a multiple request transaction being in progress), and a second user having their own unique login ID may access the session state data and continue with the session. This process requires the use of a permanent session owner/login ID cross-reference table or the like that identifies each session owner and the corresponding login ID's associated with that owner. The snapshots of session data are similar to the snapshots shown in FIG. 4, except the snapshot is associated with a session owner, instead of a session ID.

FIG. 8 shows an example wherein session owner “owner1” is associated with login ID's johndoe and janedoe, and session owner “owner2” is associated with login ID's marysmith and johnsmith. In this example, user1 and user2 both log out of an uncompleted session at time=t1. Their respective snapshots reflect the state at time=t1, in the same manner as described in FIG. 4. However, the snapshots are associated with owner1 and owner2 instead of the login ID's for user 1 and user 2, respectively. At time=t2, users 3 and 4 log into the website and enter their login ID's. Since the login ID for users 3 and 4 are cross-referenced to owners 1 and 2, respectively, the system checks the snapshots to determine if there are any currently stored snapshots for these session owners. In the current example, both snapshots exist. Accordingly, at time=t2, the sessions created for users 3 and 4 are populated with data from their respective snapshots. In this manner, users 3 and 4 may continue with a session at the same point in time that users 1 and 2 left off. If no current snapshots existed, then users 3 and 4 would have started their sessions with completely new session data.

The snapshots are provided with their own timeout that, when reached, causes them to expire. Upon expiration, session state persistence is no longer possible. The timeout may be set for any desired period (e.g., two days, one month).

The present invention provides users with session state persistence. That is, the present invention bridges current HTTP session management boundaries (e.g., browser/device). In the example above, the user conducts a transaction at an e-commerce website. However, the scope of the present invention includes other types of applications. Consider, for example, a worker who uses a form to enter timesheet data. The user may log in to a specific website via a public network from a browser of a personal computer and begin a timesheet form. The timesheet entries are stored in the data fields of the session and also stored in the snapshot. The user may then either log out or just close the browser. The user may then log back in at the end of the day from either same personal computer or from a different device, such as a wireless device or a voice-activated system and can complete the timesheet form. Upon recognizing the user via the login ID or some other identifier, the new session is populated with the previously submitted time entries, and the user can continue entering time at the same point in which the user left off.

Non-Persistent Solution

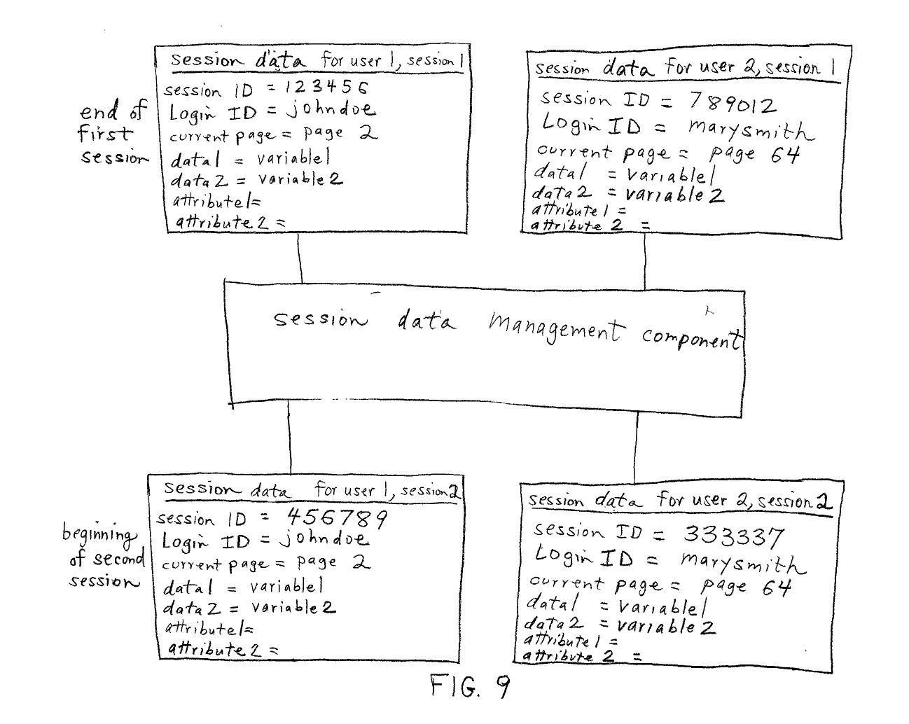

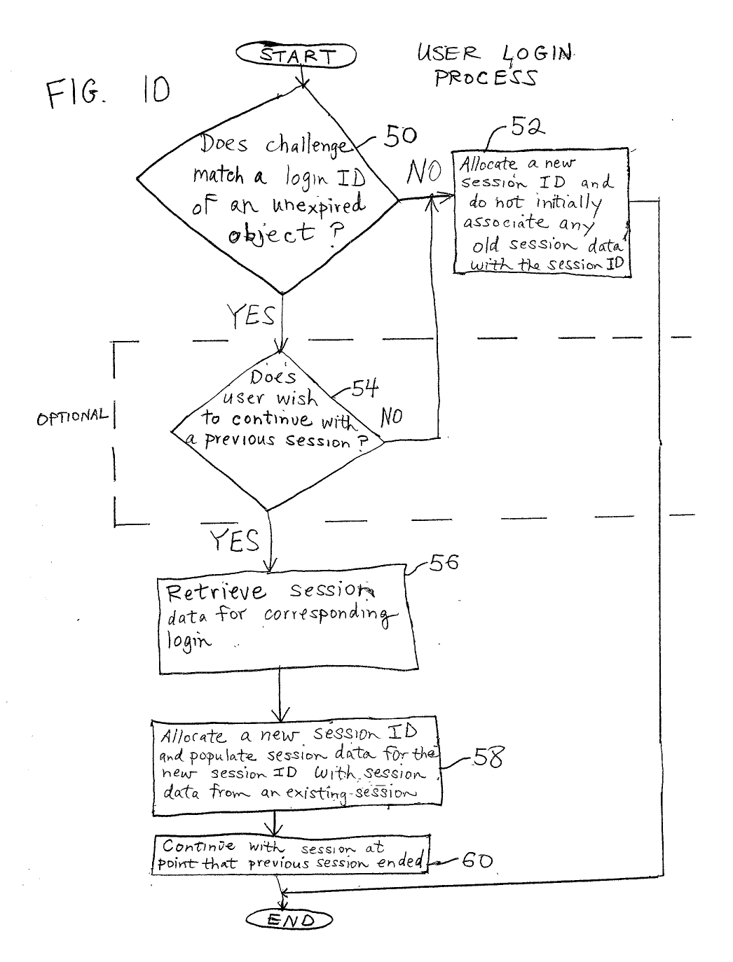

FIG. 9 and FIG. 10 illustrate some of the conceptual aspects of a non-persistent solution using the same session data and user login scenario as illustrated in the persistent solution. Thus, the description of the non-persistent solution will be limited to highlighting the differences between the solutions.

The non-persistent solution does not use snapshots to transfer session data across multiple sessions. Instead, when it is desired to use session data across multiple sessions, session data is directly retrieved from the session data of the previous session and directly copied into a new session under the control of a session data management component, as shown in FIG. 10 and described in more detail below. In a plural server website embodiment, a session manager is also needed to coordinate the process, as also described in more detail below. In a single website server embodiment, sessions are not distributed among plural servers and thus no session manager is needed.

FIG. 9 shows the session data for user 1 and user 2 at the end of a first session (top row) and at the beginning of a new session (bottom row). Except for the session ID, the session data are identical.

FIG. 10 shows a flowchart of the user login process for the non-persistent solution. FIG. 10 is comparable to FIG. 6 of the persistent solution and thus is not explained in detail. Three main differences exist between the persistent solution in FIG. 6 and the non-persistent solution in FIG. 10, as highlighted below:

Step 22 of FIG. 6: Does challenge match a login ID of a retained snapshot?

Step 50 of FIG. 10: Does challenge match a login ID of an unexpired, valid session?

Step 28 of FIG. 6: Retrieve snapshot data for corresponding login.

Step 56 of FIG. 10: Retrieve session data for corresponding login.

Step 30 of FIG. 6: Allocate a new session ID and populate session data for the new session ID with session data retrieved from the snapshot.

Step 58 of FIG. 10: Allocate a new session ID and populate session data for the new session ID with session data from an existing session.

In the examples above, a login ID is used to identify snapshots or sessions that have session state data that is desired to be used in subsequent sessions. In the solutions described in detail below, a “unique session key” performs the function of the login ID. Well-known examples of session keys include encrypted information about the user, a hash of the login ID and the login ID itself.

One embodiment of the present invention is implemented in an object-oriented environment using a conventional session management technique that creates and uses “session objects.” One form of a session object is the HttpSession object within a Java servlet-based server. This object is used by the servlet to store or retrieve information about a particular client who has established a session with a server. The HttpSession object maintains information about a single session. The session object typically contains session state data, but may also contain other session data that is not state-specific. As noted above, the combination of the “session state data” and “other session data” is referred to as “session data.” The scope of the present invention includes non-object-oriented environments and session stores.

Furthermore, although the present invention is described in the context of a user being a person, a user may also be an external system.

### II. Detailed Description

1 Overview

2 Non-Persistent

2.1 Components

2.1.1 Application Server

2.1.2 Session Broker

2.1.3 Session Manager

2.1.4 Session Keys

2.2 Session Establishment

2.2.1 Establishing A New HTTP Session With A New Session Key

2.2.2 Establishing A New HTTP Session With An Existing Session Key

2.2.3 Establishing A New HTTP Session With An Existing Session Key (Same Broker)

2.3 HTTP Session Timeout

2.4 Limit Copied Data

3 Persistent

3.1 Components

3.1.1 Application Server

3.1.2 Session Broker

3.1.3 Snapshot Data Store

3.1.4 Session Keys

3.2 Session Establishment

3.2.1 Establishing A New HTTP Session With A New Session Key

3.2.2 Establishing A New HTTP Session With An Existing Session Key

3.2.3 Establishing A New HTTP Session With An Existing Session Key (Same Broker)

3.3 Snapshot Updates

3.4 HTTP Session Timeout

3.5 Limit Copied Data

1 Overview

Persistent and non-persistent solutions, as described above, are explained in more detail below.

2 Non-Persistent

2.1 Components

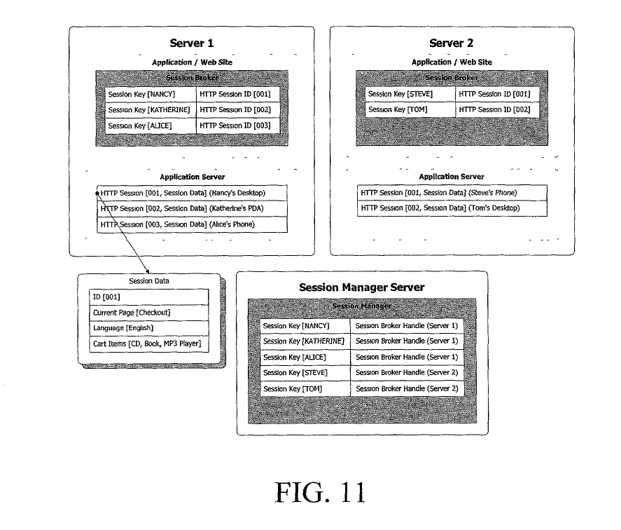

FIG. 11 shows the basic components of a non-persistent solution populated with sample data.

2.1.1 Application Server

The application server is an external component that provides HTTP session tracking capabilities (cookies, URL rewriting etc), including the ability to associate session data with a user's session.

2.1.2 Session Broker

Each application (a web site is considered an application) maintains one session broker on every server on which that application is running. If multiple applications are running on the same server, then each application will have its own session broker. Each session broker is configured to communicate with one session manager. Each session broker has the following responsibilities:

(a) Track a reference to the server maintained session data, and associate that reference with a unique key that identifies a session that is to be shared across HTTP sessions.

(b) Notify the session manager that a particular session key is being used by an active HTTP session.

(c) Notify the session manager when a session key is no longer being used.

(d) Merge session data from the previous HTTP session into the new HTTP session when both sessions are identified with the same key.

(e) Provide session data to another session broker when that broker is taking over an active session.

Note: An application may wish to participate in sharing sessions with different session managers. If this were the case, the session broker would maintain a list of session managers to communicate HTTP session information to. If each session manager uses a different unique key scheme, the application would need to maintain multiple session brokers, one for each session manager.

2.1.3 Session Manager

Each application or set of applications that wish to share sessions communicate with one and only session manager. That session manager may be running on the same server, with applications and their session brokers or an entirely separate server. Regardless, all session brokers treat the session manager as if it is running on a separate server. The session manager has the following responsibilities:

(a) Track all session keys that are being used by all session brokers reporting to it.

(b) For each session key, maintain a reference to the session broker that is tracking the actual HTTP session.

(c) When a session is being transferred from one session broker to another, provide the session broker handle to the broker that will own the session going forward.

(d) Guarantee that a session key does not get associated with more than one session broker.

2.1.4 Session Keys

A session key is some data that uniquely identifies a session that is to be shared across HTTP sessions. This key can be constructed in any manner. When a user or other system has establishes an HTTP session with an application, it is the application's responsibility to determine from the user, or other information available to it, the session key to use. When the user or system attaches through another HTTP session the application must be able to generate the same session key in order to share sessions. Session keys are typically pieces of information like a login name, or email address, that uniquely identify the user.

2.2 Session Establishment

2.2.1 Establishing a New HTTP Session with a New Session Key

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the HTTP session and the unique session key.

4. The session broker tracks a reference to the session data associated with the session key.

5. The session broker notifies its session manager that a new session has been established and gives it the session key for the new session.

6. The session manager determines that no other session brokers are currently using that key.

7. The session manager tracks a reference to the session broker along with the session key.

8. The session manager notifies the broker that no other brokers are using the given session key.

2.2.2 Establishing a New HTTP Session with an Existing Session Key

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the session and the unique session key.

4. The session broker tracks a reference to the session data associated with the session key.

5. The session broker asks the session manager if the session key is currently in use.

6. The session manager determines that another session broker (hereafter referred to as the “old” broker) has an active session with that key.

7. The session manager notifies the new session broker that the session key is already in use and identifies the old session broker that is using that key.

8. The new session broker retrieves the old HTTP session data from the old session broker and merges it into the new HTTP session.

9. The new session broker notifies the old session broker that the HTTP session associated with the session key needs to be terminated (invalidated).

10. The old session broker terminates the old HTTP session (or requests that the server or other resource maintaining the HTTP session terminate that HTTP session).

11. The old session broker notifies the session manager that the session key is no longer being used by it.

12. The session manager stops tracking the session key and associated session broker reference.

13. The new session broker notifies the session manager that a new session has been established and gives it the session key for the new session.

14. The session manager tracks a reference to the session broker along with the session key.

2.2.3 Establishing a New HTTP Session with an Existing Session Key (Same Broker)

This path exists for efficiency's sake. There is no need to communicate with the session manager if the broker is already tracking the old session. The same key will be used and the session manager is already aware that the broker has that key active.

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the session and the unique session key.

4. The session broker determines that it is already tracking an HTTP session with the given session key.

5. The session broker retrieves the old HTTP session data and merges it into the new HTTP session.

6. The session broker terminates the old HTTP session (or requests that the server or other resource maintaining the HTTP session terminate that HTTP session).

7. The session broker replaces the reference to the old HTTP session associated with the session key with a reference to the new HTTP session.

2.3 HTTP Session Timeout

When an HTTP session is tracked by cookies or URL-rewriting, the server has no way of knowing that a particular session never intends to communicate with the server again (the user closes their browser). In order to avoid requiring resources to track every session ever established, servers generally establish a timeout for HTTP sessions. If more than the set timeout period elapses between requests on a session, the server terminates (invalidates) the session and releases resources associated with it.

In order participate in this resource cleanup, servers generally offer a way for applications to be notified when a session is terminated. When this occurs, the session broker notifies the session manager that it is no longer using the key. The session manager stops tracking the key and associated session broker reference.

2.4 Limit Copied Data

The application can identify to the session broker a list of session data attributes that should not be copied between sessions. This avoids copying attributes that are not needed or are undesired.

3. Persistent

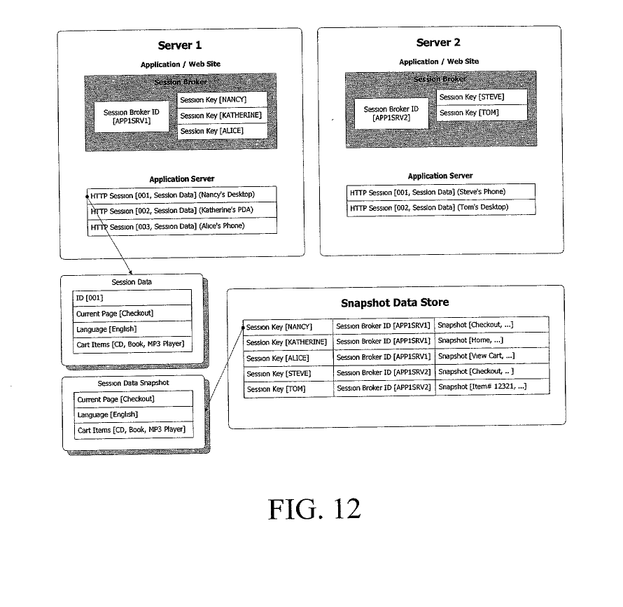

FIG. 12 shows the basic components of a persistent solution populated with sample data.

3.1 Components

3.1.1 Application Server

This provides the same functionality as in the non-persistent implementation.

3.1.2 Session Broker

Each application (a web site is considered an application) maintains one session broker on every server on which that application is running. If multiple applications are running on the same server, then each application will have its own session broker. Each session broker has a unique ID assigned to it. It is the application's responsibility to configure the session broker with this ID and guarantee that it is not in use by other session brokers. Each session broker has the following responsibilities:

(a) Determine if a snapshot currently exists in the snapshot data store

(b) Create a snapshot when a new session is established.

(c) Track the session keys currently associated with it.

(d) Update the snapshot when requested by the application.

(e) Remove the snapshot when requested by the application.

(f) Determine if the snapshot has been taken over by another session broker when requested by the application.

(g) Merge session data from the snapshot of a previous HTTP session into the new HTTP session when both sessions are identified with the same key.

Note: An application may specify that the snapshot be updated with every request, or for the sake of better performance, may wish to notify the session broker to update the data only when it knows the data has been changed.

Note: When a user or system makes a request, it is the application's responsibility to ensure that the session has not been taken over by another session broker since the last request was made on the session.

3.1.3. Snapshot Data Store

Each application or set of applications that wish to share sessions interact with one and only snapshot data store. Each snapshot that is stored is associated with a session key.

(a) Store a snapshot of session data, associated with a session key and a session broker ID.

(b) Guarantee that a session key is only associated with one snapshot at any given time.

Note: There are a variety of methods in which snapshots can be stored, including, but not limited to, a relation database management system (RDBMS), in memory by a shared resource, in a naming or lookup service, or even in a flat file. In whichever method it is implemented, the session broker interacts directly with the snapshot data store.

3.1.4 Session Keys

Session keys in the persistent solution are identical to those in the non-persistent solution.

3.2 Session Establishment

3.2.1 Establishing a New HTTP Session with a New Session Key

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the session and the unique session key.

4. The session broker determines that it is not currently tracking a snapshot for the session key and that the snapshot data store does not contain a snapshot associated with the session key.

5. The session broker tracks that it is maintaining a snapshot for the session key.

6. The session broker copies the data out of the session and records it in a new snapshot in the snapshot data store, associated with the session key and its session broker ID.

7. The snapshot data store guarantees that session key is not already associated with another snapshot.

3.2.1 Establishing a New HTTP Session with an Existing Session Key

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the session and the unique session key.

4. The session broker determines from the snapshot data store that the session key is currently associated with an existing snapshot.

5. The session broker retrieves the old HTTP session data from the snapshot and merges it into the new HTTP session.

6. The session broker updates the snapshot of the session data with the new HTTP session's data (the new session may contain new data that is not yet in the snapshot).

7. The session broker updates the session broker ID for the snapshot in the snapshot data store.

8. The session broker tracks that it is maintaining a snapshot for the session key.

Note: In this scenario, it is the application's responsibility to determine when an existing HTTP session is trying to make a request for a session key associated with a snapshot currently maintained by another session broker. When this occurs, it must invalidate the old HTTP session.

3.2.3 Establishing a New HTTP Session with an Existing Session Key (Same Broker)

This path exists so that a new HTTP session handled by the same broker can automatically invalidate the old HTTP session. There are also minor efficiencies gained.

1. A user or system makes a request from a website and the server creates a new HTTP session for that client.

2. The application uses information available to it to manufacture a unique session key to associate with that user or system. This does not have to occur immediately—for example a login page can be presented to the user and user credentials captured from it.

3. The application notifies the session broker of the new session, handing it a reference to the session and the unique session key.

4. The session broker determines that it is already tracking an HTTP session with the given session key.

5. The session broker retrieves the old HTTP session data from the snapshot and merges it into the new HTTP session.

6. The session broker updates the snapshot of the session data with the new HTTP session's data (the new session may contain new data that is not yet in the snapshot).

7. The session broker terminates the old HTTP session (or requests that the server or other resource maintaining the HTTP session terminate that HTTP session).

8. The session broker tracks that it is maintaining a snapshot for the session key.

3.3 Snapshot Updates

The application can notify the session broker that its session data has changed, and that the snapshot should be updated. This is similar to 3.2.3, except that the session is not invalidated after the data has been updated. Instead of merging the old data with the new, the existing snapshot is updated with any changes.

3.4 HTTP Session Timeout

(See the non-persistent solution for a definition of HTTP session timeout)

When an HTTP session times out, the session broker removes the snapshot from the snapshot data store and stops tracking the session key associated with the HTTP session.

3.5 Limit Copied Data

The same technique defined in the non-persistent solution can be used in the persistent solution.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of using session state data across sessions, the method comprising:
(a) establishing a first session, the session including session state data;
(b) establishing a second session; and
(c) determining if the second session desires to access session state data established by the first session, and if so, using at least some of the session state data from the first session during the second session to establish the initial session state during the second session.

2. The method of claim 1 wherein the first and second sessions have session owner data associated therewith, and step (c) is performed by determining if the session owner data of the second session matches with the session owner data of the first session.

3. The method of claim 2 wherein the session owner data is a unique user ID.

4. The method of claim 3 wherein a plurality of different user ID's are assigned to the same session owner, and step (c) is performed by determining if the session owner associated with the user ID of the second session matches the session owner associated with the user ID of the first session.

5. The method of claim 1 wherein each session has an associated session object that includes session state data which defines the session state, and step (c) further comprises using the session state data in the session object of the first session in the session object of the second session to establish the initial session state during the second session.

6. The method of claim 5 further comprising:
(d) maintaining a copy of at least some of the session state data associated with the first session, wherein the data in the copy is updated whenever session state data in the session object that also exists in the copy is changed, and step (c) further comprises using the session state data in the copy to populate the session object during the second session.

7. The method of claim 1 wherein the sessions are HTTP sessions and the session state data are HTTP session data.

8. The method of claim 1 further comprising:
(d) maintaining a copy of the current state of at least some of the session state data associated with the first session, wherein step (c) further comprises using the session state data in the copy during the second session.

9. An article of manufacture for using session state data across sessions, the article of manufacture comprising a computer-readable medium holding computer-executable instructions for performing a method comprising:
(a) establishing a first session, the session including session state data;
(b) establishing a second session; and
(c) determining if the second session desires to access session state data established by the first session, and if so, using at least some of the session state data from the first session during the second session to establish the initial session state during the second session.

10. The article of manufacture of claim 9 wherein the first and second sessions have session owner data associated therewith, and step (c) is performed by determining if the session owner data of the second session matches with the session owner data of the first session.

11. The article of manufacture of claim 10 wherein the session owner data is a unique user ID.

12. The article of manufacture of claim 11 wherein a plurality of different user ID's are assigned to the same session owner, and step (c) is performed by determining if the session owner associated with the user ID of the second session matches the session owner associated with the user ID of the first session.

13. The article of manufacture of claim 9 wherein each session has an associated session object that includes session state data which defines the session state, and step (c) further comprises using the session state data in the session object of the first session in the session object of the second session to establish the initial session state during the second session.

14. The article of manufacture of claim 13 wherein the computer-executable instructions perform a method further comprising:
(d) maintaining a copy of at least some of the session state data associated with the first session, wherein the data in the copy is updated whenever session state data in the session object that also exists in the copy is changed, and step (c) further comprises using the session state data in the copy to populate the session object during the second session.

15. The article of manufacture of claim 9 wherein the sessions are HTTP sessions and the session state data are HTTP session data.

16. The article of manufacture of claim 9 wherein the computer-executable instructions perform a method further comprising:
(d) maintaining a copy of the current state of at least some of the session state data associated with the first session, wherein step (c) further comprises using the session state data in the copy during the second session.
